(19) United States
(12) Patent Application Publication
(10) Pub. No.: US 2026/0016720 A1
(43) Pub. Date: Jan. 15, 2026

(54) DISPLAY STRUCTURE

(71) Applicant: HANNSTAR DISPLAY CORPORATION, Taipei City (TW)

(72) Inventors: Yu-Chi CHIAO, Taipei City (TW); I-Tung CHEN, Taipei City (TW); Jhih Jie HUANG, Taipei City (TW); Yao-Jen CHANG, Taipei City (TW); Ya-Jing YANG, Taipei City (TW); Che-Wei LI, Taipei City (TW); Yi-Ting HSU, Taipei City (TW); Yu-Hsun LAI, Taipei City (TW)

(21) Appl. No.: 19/090,499

(22) Filed: Mar. 26, 2025

(30) Foreign Application Priority Data
Jul. 11, 2024 (TW) 113126077

(51) Int. Cl. G02F 1/1335; G02F 1/1368

(52) U.S. Cl. CPC G02F 1/133553; G02F 1/1368

(57) ABSTRACT

A reflection-enhanced display structure is provided, which includes a substrate; a semiconductor component layer; a overcoating layer with a groove; a reflective layer provided on the overcoating layer and covering a side surface and a bottom surface of the groove. The reflective layer includes a reflection-enhancement structure, which at least provides with: (i) the reflective layer having a side surface and a bottom surface in the groove, wherein the side surface of the groove and the side surface of the reflective layer are not parallel to each other; (ii) a light penetration enhancement layer provided on the reflective layer and covering the side surface and bottom surface of the reflective layer; (iii) a reflective micro-structure layer provided on the reflective layer and covering the side surface and bottom surface of the reflective layer. The present disclosure achieves the improvement of light reflection by providing the reflection-enhancement structure.

### CROSS-REFERENCE TO RELATED APPLICATIONS

This application claims priority to Taiwan Patent Application No. 113126077, filed on Jul. 11, 2024, the disclosure of which is herein incorporated by reference in their entirety.

### FIELD OF INVENTION

The present invention relates to display structures and, more particularly, to display structures for enhancing reflection in reflective type and transflective type displays.

### BACKGROUND OF INVENTION

Liquid crystal displays (LCDs) can be generally divided into transmissive type LCDs, reflective type LCDs, and transflective type LCDs. A transmissive type display is composed of a backlight and a display panel, and it requires a stable light source provided by the backlight. The reflective type display reflects ambient light that is introduced into the display and reflected back to the viewer's eyes. Since the reflective type display does not require the backlight, it can be made slim and has a lower power consumption. However, the intensity of ambient light is easy to affect the imaging quality, so as to limit its application. The transflective type displays combine both advantages of the transmissive and reflective types, they use ambient light as a light source to reduce the power consumption for display, and are clearer and more distinct than the transmissive type display under the bright sunlight. In addition, under low-light conditions, the transflective type displays can provide the required brightness through the backlight, thereby avoiding insufficient brightness that affects the imaging quality in low-light environments.

However, in order to further reduce energy consumption and meet energy-saving requirements, it is necessary to increase reflection efficiency, thereby improving light reflection and enhancing display performance.

Therefore, it is necessary to provide display structures to solve the problems existing in the prior art.

### SUMMARY OF INVENTION

In this regard, the present invention provides a display structure to solve the insufficient reflectivity in prior art. It can further solve the low reflectivity caused by refracted light due to the uneven surface of the reflective layer.

A main objective of the present invention is to provide a display structure that can improve the effect of light reflection by providing a groove in an overcoating layer and configuring a side surface of a reflective layer and a side surface of the groove to be non-parallel to each other.

A secondary objective of the present invention is to provide a display structure that can increase the transmittance of the light and thus increase the utilization rate of reflected light by providing a light penetration enhancement layer on the reflective layer.

To achieve the above objectives, an embodiment of the present invention provides a reflection-enhanced display structure including a substrate; a semiconductor component layer provided on the substrate; an overcoating layer provided on the semiconductor component layer, wherein the overcoating layer has a groove; a reflective layer provided on the overcoating layer and covering a side surface and a bottom surface of the groove, wherein the reflective layer comprises a reflection-enhancement structure, and the reflection-enhancement structure at least provides with: the reflective layer having a side surface and a bottom surface in the groove, wherein the side surface of the groove and the side surface of the reflective layer are not parallel to each other; and/or a light penetration enhancement layer provided on the reflective layer and covering the side surface and bottom surface of the reflective layer; and/or a reflective micro-structure layer provided on the reflective layer and covering the side surface and bottom surface of the reflective layer.

In some embodiments of the present invention, an angle between the side surface and the bottom surface of the reflective layer ranges from 110 to 130 degrees.

In some embodiments of the present invention, an angle between the side surface and the bottom surface of the groove ranges from 90 to 100 degrees.

In some embodiments of the present invention, the display structure further includes a transparent electrode layer provided between the semiconductor component layer and the overcoating layer.

In some embodiments of the present invention, the material of the light penetration enhancement layer is selected from one of polyacrylate, epoxy resin, benzocyclobutene, polyimide, polyurethane, polysilane, polysiloxane, poly (silicone-acrylic), silicon nitride, silicon oxide, silicon oxynitride or a combination thereof.

In some embodiments of the present invention, the reflective micro-structure layer includes a plurality of reflection enhancement bumps, and a shape of the reflection enhancement bump is hemispherical, rectangular, or conical.

In some embodiments of the present invention, the light penetration enhancement layer is provided on the reflective micro-structure layer.

Moreover, another embodiment of the present invention provides a reflection-enhanced display structure including a substrate, wherein a side of the substrate has a reflection-enhancement structure, the reflection-enhancement structure comprises at least one groove, and the reflection-enhancement structure is at least provided with: a reflective layer provided on a side portion and a bottom portion of the groove, and an angle between the side portion and the bottom portion of the groove being an obtuse angle; and/or the reflective layer and a light penetration enhancement layer stacked with each other; and/or a reflective micro-structure layer provided on the reflective layer.

Furthermore, yet another embodiment of the present invention provides a reflection-enhanced display panel structure including a first substrate, wherein the first substrate has a reflection-enhancement structure, the reflection-enhancement structure comprising at least one groove, and the reflection-enhancement structure at least provided with: a reflective layer provided on a side portion and a bottom portion of the groove, and an angle between the side portion and the bottom portion of the groove being an obtuse angle; and/or the reflective layer and a light penetration enhancement layer stacked each other; and/or a reflective micro-structure layer provided on the reflective layer; a second substrate provided relative to the first substrate; and a liquid crystal layer provided between the first substrate and the second substrate.

In some embodiments of the present invention, a spacer is provided on a side of the second substrate, and the spacer is provided opposite to the groove.

Compared with prior art, when ambient light is incident into the display structure of the present invention, the ambient light passes through the liquid crystal layer and is reflected by the reflection-enhancement structure, thereby improving the effect of light reflection and thus improving the display performance. In addition, in low-light environments, since the reflection-enhancement structure of the reflective layer can improve the effect of light reflection, it is not necessary to use or only needs to use a backlight with lower power consumption, thereby reducing the power consumption required for display and achieving the purpose of energy-saving.

### DRAWINGS

In order to make the above content of the present invention more apparent, the following content describes the preferred embodiments of the present application in conjunction with the accompanying drawings, the detailed explanations are made as follows.

FIG. 1 is a schematic view of a reflection-enhanced display structure according to a first embodiment of the present invention.

FIG. 2 is a schematic enlarged view of a groove structure of the first embodiment of the present invention.

FIG. 3 is a schematic view of a reflection-enhanced display structure according to a second embodiment of the present invention.

FIG. 4 is a schematic view of a reflection-enhanced display structure according to a third embodiment of the present invention.

FIGS. 5 to 7 are schematic enlarged views of reflection enhancement bumps of the reflective micro-structure layer according to the embodiments of the present invention.

FIG. 8 is a schematic view of a reflection-enhanced display structure according to a fourth embodiment of the present invention.

### DETAILED DESCRIPTION OF EMBODIMENTS

In order to make the above and other purposes, features, and advantages of the present invention more apparent and easy to understand, the following will provide preferred embodiments of the present invention and provide a detailed explanation accompanying with the attached drawings. Furthermore, the directional terms mentioned in the present invention, such as up, down, top, bottom, front, back, left, right, inside, outside, side, around, center, horizontal, lateral, vertical, longitudinal, axial, radial, uppermost or lowermost layers, are only referring to the direction of the attached drawings. Therefore, the directional terms used herein are for explaining and understanding the present invention, rather than limiting the scope of the present invention.

An embodiment of the present invention provides a reflection-enhanced display structure including a substrate; a semiconductor component layer provided on the substrate; a overcoating layer provided on the semiconductor component layer, wherein the overcoating layer has a groove; a reflective layer provided on the overcoating layer and covering a side surface and a bottom surface of the groove, wherein the reflective layer comprises a reflection-enhancement structure, and the reflection-enhancement structure at least provides with: the reflective layer having a side surface and a bottom surface in the groove, wherein the side surface of the groove and the side surface of the reflective layer are not parallel to each other; and/or a light penetration enhancement layer provided on the reflective layer and covering the side surface and bottom surface of the reflective layer; and/or a reflective micro-structure layer provided on the reflective layer and covering the side surface and bottom surface of the reflective layer.

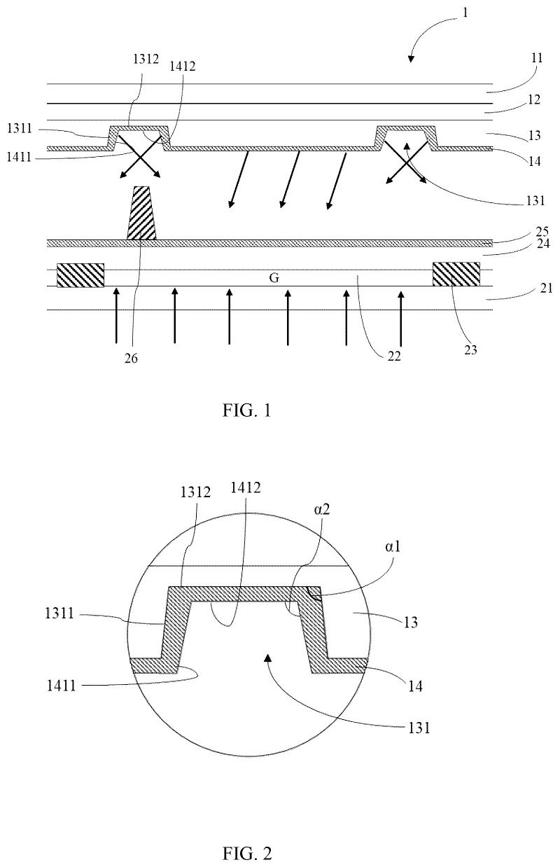

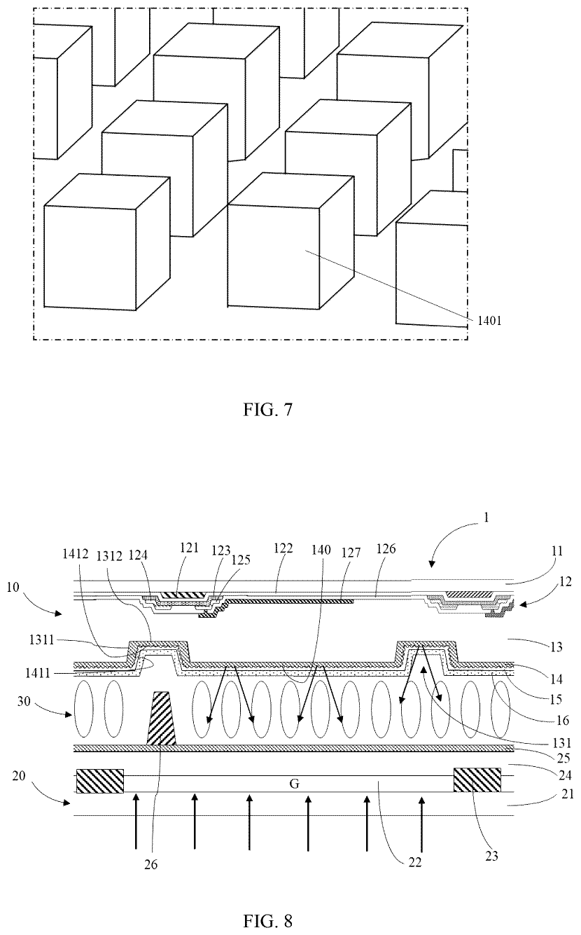

The present invention is described in detail below using FIGS. 1 to 8 to illustrate the detailed structures, assembly relationships, and operating principles of the aforementioned components in the following first to fourth embodiments. The display structure may be a reflective type LCD structure or a transflective type LCD structure.

### EXAMPLE 1

Referring to FIG. 1, FIG. 1 illustrates a schematic view of a reflection-enhanced display structure according to a first embodiment of the present invention. It should be noted that, for simplification purposes, the diagram only illustrates one pixel as an example. A display structure 1 includes a first substrate 11, a semiconductor component layer 12, an overcoating layer 13, and a reflective layer 14.

Specifically, the semiconductor component layer 12 is provided on the substrate 11. The overcoating layer 13 is provided on the semiconductor component layer 12, and the overcoating layer 13 has a groove 131. The reflective layer 14 is provided on the overcoating layer 13 and covers the side surface 1311 and the bottom surface 1312 of the groove 131. The reflective layer 14 includes a reflection-enhancement structure. In the present embodiment, the reflection-enhancement structure is provided as follows: the reflective layer 14 has a side surface 1411 and a bottom surface 1412 in the groove 131, the side surface 1311 of the groove 131, and the side surface 1411 of the reflective layer 14 are not parallel to each other. It should be noted that the position of the groove 131 is only for illustrative purposes, and it may be changed according to actual requirements.

Moreover, the display structure 1 may further include a second substrate 21. The second substrate 21 may provide a color filter layer 22 and a black light-shielding layer 23 thereon. In the present example, the color filter layer 22 may be a green (G) color filter layer. Alternatively, the color filter layer 22 may be a red (R) or a blue (B) color filter layer, and so on. Specifically, the black light-shielding layer 23 may be formed by a black photo-resist and provided in a matrix surrounding the color filter layer 22 after exposure and development process.

The color filter layer 22 and the black light-shielding layer 23 may further provide an overcoating layer 24 thereon. In addition, there may be a common electrode layer 25 on the overcoating layer 24.

Furthermore, a spacer 26 may be provided on the common electrode layer 25. The spacer 26 may be positioned in a way that corresponds to groove 131. The spacer 26 may be formed by a photoresist, such as a positive photoresist or negative photoresist. In one embodiment, after coating the photoresist on the top of the common electrode layer 25, the unexposed portion is removed by using a developer after the exposure and development process, and the columnar bumps are left as the spacers 26 to support and maintain the gap of the liquid crystal cell.

Specifically, referring to FIG. 2, FIG. 2 illustrates a schematic enlarged view of a groove structure of an embodiment of the present invention. The side surface 1311 and the bottom surface 1312 of the groove 131 have an angle α1, which is an approximately vertical structure, for example, it may range from 90 to 100 degrees. The side surface 1411 and the bottom surface 1412 of the reflective layer 14 have an angle α2, which may be an obtuse angle that is greater than α1, for example, it may range from 110 to 130 degrees.

Compared to an entirely flat reflective layer configuration, the present invention provides the groove in the overcoating layer and further configures the reflective layer inside the groove, and yet further changes an approximately vertical structure of the reflective layer to an oblique angle structure, so as to improve the effect of light reflection.

### EXAMPLE 2

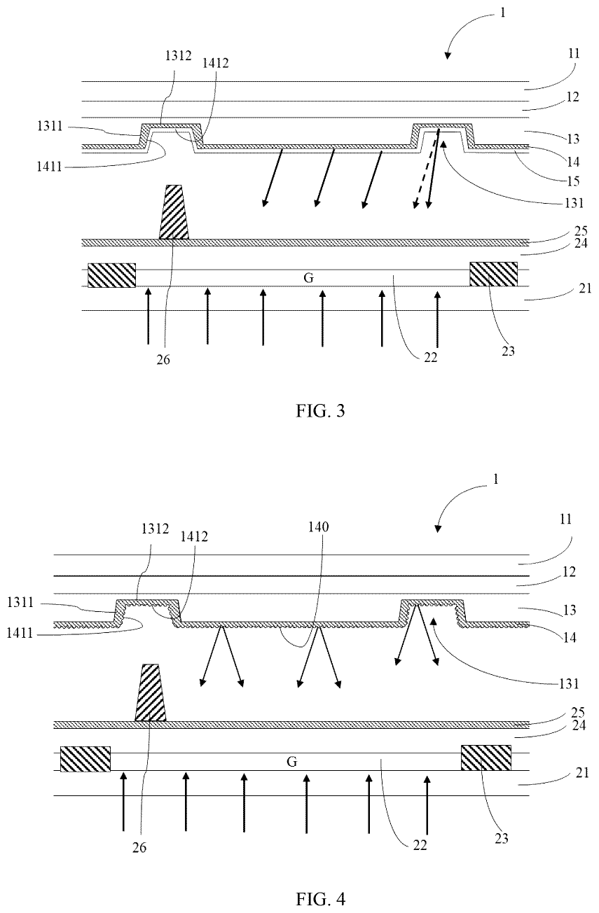

Referring to FIG. 3, FIG. 3 illustrates a schematic view of a reflection-enhanced display structure according to a second embodiment of the present invention. The configuration of the second embodiment of the reflection-enhanced display structure of the present invention is generally the same as the first embodiment, the difference is that the reflection-enhancement structure is provided as a light penetration enhancement layer 15, which is provided on the reflective layer 14 and covers the side surface 1411 and the bottom surface 1412 of the reflective layer 14. Preferably, a thickness of the light penetration enhancement layer 15 may range from 0.5 to 1.0 micrometers. It should be noted that the structure of the first embodiment of the present invention (i.e., the side surface 1311 of the groove 131 and the side surface 1411 of the reflective layer 14 are not parallel to each other) may be optionally or combined with the structure of the second embodiment of the present invention (i.e., the light penetration enhancement layer 15).

By adding a thin light penetration enhancement layer on the reflective layer to fill and level the surface of the reflective layer, the straightness of light may be increased and the diffuse reflection of light caused by the uneven surface of the reflective layer may be reduced.

In some embodiments of the present invention, the material of the light penetration enhancement layer 15 may be selected from one of polyacrylate, epoxy resin, benzocyclobutene, polyimide, polyurethane, polysilane, polysiloxane, poly (silicone-acrylic), silicon nitride, silicon oxide, silicon oxynitride, or a combination thereof. Moreover, the material of the reflective layer 14 may be metallic silver, metallic aluminum, other highly reflective metals, or a combination thereof.

### EXAMPLE 3

Referring to FIG. 4, FIG. 4 illustrates a schematic view of a reflection-enhanced display structure according to a third embodiment of the present invention. The configuration of the third embodiment of the reflection-enhanced display structure of the present invention is generally the same as the first embodiment, the difference is that the reflection-enhancement structure is provided as a reflective micro-structure layer 140, which is provided on the reflective layer 14 and covers the side surface 1411 and the bottom surface 1412 of the reflective layer 14.

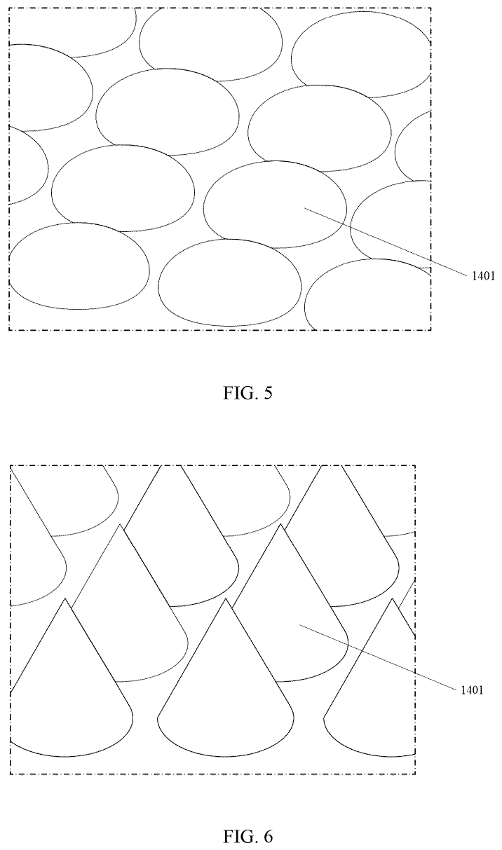

Next, referring to FIGS. 5 to 7, FIGS. 5 to 7 illustrate schematic enlarged views of reflection enhancement bumps 1401 of the reflective micro-structure layer 140 according to the embodiments of the present invention. As shown in FIGS. 5 to 7, the reflective micro-structure layer 140 may include a plurality of reflection enhancement bumps 1401, and the shape of the reflection enhancement bumps 1401 may be hemispherical, rectangular, or conical. By providing micro bump structures on the surface of the reflective layer 14, the reflectivity for light can be increased, so as to enhance the display performance. In addition, a light penetration enhancement layer 15 may be further provided on the reflective micro-structure layer 140 as illustrated in Example 2 to further enhance the reflection efficiency.

It should be noted that the above-mentioned structures, such as the side surface 1311 of the groove 131 and the side surface 1411 of the reflective layer 14 are not parallel to each other, the light penetration enhancement layer 15, and the reflective micro-structure layer 140, may be optionally configured or combined.

### EXAMPLE 4

Referring to FIG. 8, FIG. 8 illustrates a schematic view of a reflection-enhanced display structure according to a fourth embodiment of the present invention. The display structure 1 may include an array substrate 10 and a color filter substrate 20. The array substrate 10 may include a first substrate 11, a semiconductor component layer 12, a passivation layer 126, a pixel electrode layer 127, an overcoating layer 13, a reflective layer 14, and a light penetration enhancement layer 15. The semiconductor component layer 12 may include at least one thin-film transistor element. For example, the semiconductor component layer 12 may include a gate electrode 121, a gate insulating layer 122, an active layer 123, and a source electrode 124/a drain electrode 125 formed on the first substrate 11. The material of the gate electrode 121 may be formed from copper (Cu), aluminum (Al), molybdenum (Mo), titanium (Ti) or their alloys, other metals, other alloys, or other conductors. The gate insulating layer 122 may be formed to cover the gate electrode 121 and the gate line (not shown) connected to the gate electrode 121. The gate insulating layer 122 may be formed of silicon dioxide (SiO₂) or silicon nitride (SiNx). Alternatively, the gate insulating layer 122 may be formed by a multi-layer structure, such as stacking silicon dioxide (SiO₂) or silicon nitride (SiNx). The gate insulating layer 122 may be formed by depositing tetraethoxysilane (TEOS) or medium temperature deposition oxide (MTO) through the chemical vapor deposition (CVD) process.

The active layer 123 may be formed on the gate insulating layer 122, and its material may be formed from amorphous silicon, polycrystalline silicon, low-temperature polycrystalline silicon (LTPS), or metal oxides, etc.

The source electrode 124 may be formed on one side of the upper surface of the active layer 123, and the drain electrode 125 may be formed on the other side. Both the source electrode 124 and the drain electrode 125 may be formed from copper (Cu), aluminum (Al), molybdenum (Mo), titanium (Ti) or their alloys, other metals, other alloys, or other conductors. The gate electrode 121, the gate insulating layer 122, the active layer 123, the source electrode 124, and the drain electrode 125 may be composed of a thin-film transistor.

The source electrode 124 and the drain electrode 125 may be covered with the passivation layer 126. The passivation layer 126 may be formed from polyacrylate or polyimide, and its thickness may range from 2.0 microns to 3.0 microns. As a result, the thickness of the passivation layer 126 is thicker than that of the thin-film transistors to avoid parasitic capacitance.

The pixel electrode layer 127 may be formed on the passivation layer 126 and electrically connected to the drain electrode 125. The pixel electrode layer 127 may be a transparent electrode layer, its materials may be, for example, indium tin oxide (ITO) or indium zinc oxide (IZO).

It should be noted that the present embodiment illustrates the bottom gate thin-film transistor structure as an example, and it can be replaced with the top gate thin-film transistor structure or other structures as the requirement, but not limited thereto.

The overcoating layer 13 may be provided on the pixel electrode layer 127 and the passivation layer 126, and the overcoating layer 13 has a groove 131. The material of overcoating layer 13 may be selected from one of polyacrylate, epoxy resin, benzocyclobutene, polyimide, polyurethane, polysilane, polysiloxane, poly (silicone-acrylic), or a combination thereof. It should be noted that the position of the pixel electrode layer 127 can be changed as needed, but not limited thereto.

The reflective layer 14 may be provided on the overcoating layer 13 and covers the side surface 1311 and the bottom surface 1312 of the groove 131. The material of the reflective layer 14 may be metallic silver, metallic aluminum, or other high-reflectivity metals.

It should be noted that the reflective layer 14 shown in the drawings is only illustrated as an example and may be patterned to form a desired pattern without affecting the operation of the pixel electrode layer 127.

The reflective layer 14 may include a reflection-enhancement structure, and the reflection-enhancement structure at least provides with: the reflective layer 14 having a side surface 1411 and a bottom surface 1412 in the groove 131, the side surface 1311 of the groove 131 and the side surface 1411 of the reflective layer 14 are not parallel to each other; and/or a light penetration enhancement layer 15 provided on the reflective layer 14 and covering the side surface 1411 and bottom surface 1412 of the reflective layer 14; and/or a reflective micro-structure layer 140 provided on the reflective layer 14 and covering the side surface 1411 and bottom surface 1412 of the reflective layer 14.

It should be noted that, although the present embodiment shows the above three configurations simultaneously, the side surface 1311 of the groove 131 and the side surface 1411 of the reflective layer 14 are not parallel to each other, the light penetration enhancement layer 15 and the reflective micro-structure layer 140 may be optionally configured or configured the combination thereof.

An alignment layer 16 may be provided on the reflective layer 14, to align the liquid crystal molecules in a uniform direction and provide the liquid crystal pre-tilt angle.

In addition, the color filter substrate 20 may include a second substrate 21, a color filter layer 22, a black light-shielding layer 23, an overcoating layer 24, a common electrode layer 25, and a spacer 26. The color filter layer 22 and the black light-shielding layer 23 are provided on the second substrate 21. In the present example, the color filter layer 22 may be a green (G) color filter layer. Alternatively, the color filter layer 22 may be a red (R) or a blue (B) color filter layer, and so on.

The overcoating layer 24 may be provided on the color filter layer 22 and the black light-shielding layer 23.

Moreover, the common electrode layer 25 may be provided on the overcoating layer 24. The common electrode layer 25 may be a transparent electrode layer, its materials may be, for example, indium tin oxide (ITO) or indium zinc oxide (IZO).

Furthermore, the spacer 26 may be provided on the common electrode layer 25. In addition, there may be another alignment layer (not shown) provided on the common electrode layer 25.

The spacer 26 may be positioned in a way that corresponds to groove 131. A liquid crystal layer 30 may further provided between the array substrate 10 and the color filter substrate 20.

When the ambient light is incident into and passing through the color filter substrate 20, the common electrode layer 25 and the pixel electrode layer 127 are applied an electric field to deflect the liquid crystal molecules, so that the ambient light passing through the liquid crystal layer 30 is reflected by the reflection-enhancement structure of the reflective layer 14, thereby enhancing the light reflection and improving the display performance. In addition, in low-light environments, since the reflection-enhancement structure of the reflective layer 14 can improve the effect of light reflection, it is not necessary to use or only needs to use a backlight with lower power consumption, thereby reducing the power consumption required for display and achieving the purpose of energy-saving.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

What is claimed is:

1. A reflection-enhanced display structure, comprising:
a substrate;
a semiconductor component layer provided on the substrate;
an overcoating layer provided on the semiconductor component layer, wherein the overcoating layer has a groove; and
a reflective layer provided on the overcoating layer and covering a side surface and a bottom surface of the groove, wherein the reflective layer comprises a reflection-enhancement structure, and the reflection-enhancement structure at least provides with:
the reflective layer having a side surface and a bottom surface in the groove, wherein the side surface of the groove and the side surface of the reflective layer are not parallel to each other; and/or
a light penetration enhancement layer provided on the reflective layer and covering the side surface and bottom surface of the reflective layer; and/or
a reflective micro-structure layer provided on the reflective layer and covering the side surface and bottom surface of the reflective layer.

2. The display structure according to claim 1, wherein an angle between the side surface and the bottom surface of the reflective layer ranges from 110 to 130 degrees.

3. The display structure according to claim 2, wherein an angle between the side surface and the bottom surface of the groove ranges from 90 to 100 degrees.

4. The display structure according to claim 1, further comprising a transparent electrode layer provided between the semiconductor component layer and the overcoating layer.

5. The display structure according to claim 1, wherein the material of the light penetration enhancement layer is selected from one of polyacrylate, epoxy resin, benzocyclobutene, polyimide, polyurethane, polysilane, polysiloxane, poly (silicone-acrylic), silicon nitride, silicon oxide, silicon oxynitride or a combination thereof.

6. The display structure according to claim 1, wherein the reflective micro-structure layer comprises a plurality of reflection enhancement bumps, and a shape of the reflection enhancement bump is hemispherical, rectangular, or conical.

7. The display structure according to claim 1, wherein the light penetration enhancement layer is provided on the reflective micro-structure layer.

8. A reflection-enhanced display structure, comprising:
a substrate, wherein a side of the substrate has a reflection-enhancement structure, the reflection-enhancement structure comprises at least one groove, and the reflection-enhancement structure is at least provided with:
a reflective layer provided on a side portion and a bottom portion of the groove, and an angle between the side portion and the bottom portion of the groove being an obtuse angle; and/or
the reflective layer and a light penetration enhancement layer stacked with each other; and/or
a reflective micro-structure layer provided on the reflective layer.

9. The display structure according to claim 8, wherein an angle between the side surface and the bottom surface of the reflective layer ranges from 110 to 130 degrees.

10. The display structure according to claim 9, wherein an angle between the side surface and the bottom surface of the groove ranges from 90 to 100 degrees.

11. The display structure according to claim 8, wherein the material of the light penetration enhancement layer is selected from one of polyacrylate, epoxy resin, benzocyclobutene, polyimide, polyurethane, polysilane, polysiloxane, poly (silicone-acrylic), silicon nitride, silicon oxide, silicon oxynitride or a combination thereof.

12. The display structure according to claim 8, wherein the reflective micro-structure layer comprises a plurality of reflection enhancement bumps, and a shape of the reflection enhancement bump is hemispherical, rectangular, or conical.

13. The display structure according to claim 8, wherein the light penetration enhancement layer is provided on the reflective micro-structure layer.

14. A display panel structure for enhancing reflection, comprising:
a first substrate, wherein the first substrate has a reflection-enhancement structure, the reflection-enhancement structure comprising at least one groove, and the reflection-enhancement structure at least provided with:
a reflective layer provided on a side portion and a bottom portion of the groove, and an angle between the side portion and the bottom portion of the groove being an obtuse angle; and/or the reflective layer and a light penetration enhancement layer stacked with each other; and/or
a reflective micro-structure layer provided on the reflective layer;
a second substrate provided relative to the first substrate; and
a liquid crystal layer provided between the first substrate and the second substrate.

15. The display panel structure according to claim 14, wherein a spacer is provided on a side of the second substrate, and the spacer is provided opposite to the groove.

16. The display structure according to claim 14, wherein an angle between the side surface and the bottom surface of the reflective layer ranges from 110 to 130 degrees.

17. The display structure according to claim 16, wherein an angle between the side surface and the bottom surface of the groove ranges from 90 to 100 degrees.

18. The display structure according to claim 14, wherein the material of the light penetration enhancement layer is selected from one of polyacrylate, epoxy resin, benzocyclobutene, polyimide, polyurethane, polysilane, polysiloxane, poly (silicone-acrylic), silicon nitride, silicon oxide, silicon oxynitride or a combination thereof.

19. The display structure according to claim 14, wherein the reflective micro-structure layer comprises a plurality of reflection enhancement bumps, and a shape of the reflection enhancement bump is hemispherical, rectangular, or conical.

20. The display structure according to claim 14, wherein the light penetration enhancement layer is provided on the reflective micro-structure layer.
